(19) United States
(12) Patent Application Publication
(10) Pub. No.: US 2019/0321770 A1
(43) Pub. Date: Oct. 24, 2019

(54) Cyclonic System for Enhanced Separation of Fluid Samples and the Like with High Flow Capacity, and Method Therefore

(71) Applicant: Mayeaux Holding LLC, Gonzales, LA (US)

(72) Inventor: Valmond Joseph St Amant, III, St Amant, LA (US)

(21) Appl. No.: 15/375,103

(22) Filed: Dec. 11, 2016

Related U.S. Application Data
(60) Provisional application No. 62/267,595, filed on Dec. 15, 2015.

(51) Int. Cl. B01D 50/00; B01D 45/16; B01D 46/00; G01N 1/22

(52) U.S. Cl. CPC B01D 50/002; B01D 45/16; B01D 46/0031; G01N 2001/2267; B01D 2271/027; B01D 2271/02; G01N 1/2247

(57) ABSTRACT

A cyclonic filter separator with liquid block capabilities formed to separate liquids in a fluid stream for on-stream and spot sampling of natural gas or the like, particularly pressurized process gas having liquid entrained therein, otherwise referenced as multiphase or “wet”. The present invention incorporates a liquid block apparatus downstream the cyclonic separator to provide to further prevent liquid passing therethrough. A coalescing filter or the like (shown in cylindrical, cartridge form) may be situated downstream the liquid block to remove entrained liquids from the fluid stream, providing three liquid separation systems in series, ensuring a dry gas sample stream for analysis or the like.

### BENEFIT CLAIM

The present application claims the benefit of U.S. Provisional patent Application Ser. No. 62/267,595 filed Dec. 15, 2015, listing as inventor Valmond Joseph St Amant III, entitled “Cyclonic System for Enhanced Separation of Fluid Samples and the Like with High Flow Capacity, and Method Therefore”.

### FIELD OF THE INVENTION

The invention relates to sampling of pressurized process fluids for on-stream and spot sampling of pressurized process fluid such as natural gas or the like having liquid entrained therein, or otherwise referenced as multiphase or “wet”. The present invention contemplates a cyclonic filtration system formed to separate and exclude entrained liquids in the process gas stream, preventing same from entering the sample stream, and is designed to be especially suitable for high flow applications. The preferred embodiment of the invention contemplates the added feature of a filter cartridge or tube forming a coalescing element and/or a float-type liquid block to provide a safeguard to exclude any liquid, even with high flow applications, to provide a dry gas sample stream for analysis or the like.

### BACKGROUND OF THE INVENTION

Natural gas is bought and sold based on its heating value. It is the BTU content that determines the monetary value of a given volume of natural gas. This BTU value is generally expressed in decatherms (one million BTU). In the determination of total heat value of a given volume of gas, a sample of the gas is analyzed and from the composition its heat value per unit volume is calculated. This value is generally expressed in BTU/cu ft. The typical range of transmission quality gas ranges between 1000 and 1100 BTU/cu ft. Production gas, storage facility gas, NGL, and new found Shale Gas can have much higher heating values up to or even exceeding 1500 BTU/cu ft.

There has been a long standing controversy between gas producers and gas transporters regarding entrained liquid typically present in most high BTU/cu ft. gas (rich or “wet” gas).

Transporter tariffs require essentially liquid-free gas. Hydrocarbon liquid in the gas being transported causes operational and safety problems. The practice is to separate the liquid before entering a transport (pipe) line.

The API 14.1 standards (Manual of Petroleum Measurement Standards, 2006) scope does not provide for supercritical fluid (dense phase) or “wet gas” “(a term referenced by the Natural Gas industry as a gas that is at or below its hydrocarbon dew point temperature and/or contains entrained liquid), nor does the GPA 2166 standard (Obtaining Natural Gas Samples for Analysis by Gas Chromatography, 2005). In summary, there is no known standard which defines how to obtain a “representative sample” of a natural gas supply having entrained hydrocarbon in all forms.

Accordingly, to fully comply with the current industry standards, there exists a compelling need to effectively prevent entrained liquids from entering sample systems. Membrane-tipped probes such as the A+ Corporation Genie Probe (see U.S. Pat. Nos. 6,357,304, 6,701,794, 6,904,816, 7,004,041, and 7,134,318) have been used for many years to shed entrained liquids inside pressurized pipelines. However, these systems can be overwhelmed with excessive liquid loading, causing the maximum allowable differential pressure to be exceeded, which may force liquids through the coalescing elements, and into the sample system.

The differential pressure needed to force liquids through the coalescing elements is a function of the surface tension of the liquid as well as the construction of the coalescing element. This can be further complicated by the use of various liquid chemicals, which are routinely injected into the process, gas such as corrosion inhibitors, amine and carbon dioxide inhibitors, as well as chemicals meant to dry the gas, like alcohols and glycols.

These liquid chemicals may have low surface tensions and may penetrate coalescing elements, in which case said liquid chemicals may combine with the sample, or lower the surface

tension of entrained liquids at the coalescing membrane, making it easier for the said undesired liquids to penetrate and get past some coalescing elements. Also, some coalescing elements may have temperature limitations, and thus may be impractical for some applications.

Further, coalescing membranes or the like may have to be changed periodically as a maintenance precaution to insure reliable operation. Accordingly, there exists a need for a physical pre-filter/separator system designed to eliminate the bulk of the liquid entrained in the gas, which system would ideally be able to operate in a variety of conditions with little maintenance, and would be more reliable in operation than current systems.

Cyclonic separation techniques have been utilized various capacities for over 100 years. A typical cyclonic separator channels a fluid stream through a housing having a geometry formed to generate a vortex, exploiting centrifugal force, gravity, and pressure differentials to separate liquid particles from gaseous streams, as well as other applications.

Cyclone-type pre-filters have been used for many decades. For example, D. W. Birnstingl describes a measuring head for a conductivity meter combining a conductivity cell with a cyclone filter to filter liquid in U.S. Pat. No. 3,471,775, filed 1966.

UOP Inc. of Des Plains, Ill., describes a sampling probe that uses a V-shaped shield to pre-filter particles from sample (see U.S. Pat. No. 4,481,833 from 1984). Another company, Anarad Inc. of Santa Barbara, Calif., describes a filter probe for stack gas that uses an inertial filter with a constant bypass flow requirement to remove dust without clogging (U.S. Pat. No. 5,237,881 from 1993).

The University of Akron describes a cyclone collection vessel combined with filter media for separation of a suspension (U.S. Pat. No. 6,210,575 from 2001). M & C Products Analysis Technology, Inc. of Ventura, Calif., describes an in situ particle separation system with filter media for separating particles from gas samples (U.S. Pat. No. 7,337,683 from 2008).

More recently, the General Electric Company of Schenectady, N.Y. describes sample probe for removing particles from a gas stream using a shield and a flow reversal technique (see U.S. Pat. No. 8,087,308 from 2012).

These devices are not used to remove entrained liquids from gas samples. As far as this applicant is aware, no competitor is known to have used or contemplated using cyclone technology to solve the problem of separating entrained liquids from natural gas for sampling.

Dekati Ltd of Finland offers the CYCLONE brand cyclonic separator for removal of large particles from a Sample Stream. This device is designed to be placed in a flue gas flow in a stack as well as exterior to the stack. In either instance, an isokinetic sampling probe is utilized to draw the sample. Various isokinetic nozzles are available and may be utilized interchangeably, depending upon the circumstances of use.

Other types of fluid separators may include:
Filter Vane Separators, which utilize a structure comprising a series of plates or baffles along a passageway to exploit inertial impaction of the fluids, combined with gravity, to facilitate separation.
Centrifugal separators, which utilize centrifugal forces to separate the heavier fluid droplets or particles from the gas stream. Cyclone separators operate on this general principal, as well as well as knock-out drums.
Liquid/Gas coalescer cartridges, filters, membranes and the like are generally not suitable for removal of liquids in bulk. Relying upon inertial impaction, the particles engage a fibrous mass in a container, which may include an indirect pathway, and utilize inertial impaction and gravity to collect and drain fluid. Examples include A+ Corporation Avenger Filters U.S. Pat. No. 7,097,693 (Note one of listed inventors in '693 is the same as the present case), Welker Analyzer Liquid Shutoff (ALS) U.S. Pat. No. 5,579,803, and Welker Liquid Separator with Integral Sight Glass U.S. Pat. No. 6,818,045.
Mist Eliminators likewise rely upon the principal of inertial impaction, but instead of plates or baffles, utilize fibers, meshes or the like.

A+ Corporation makes a self-cleaning filter under the trademark TORNADO (for example, model 602). It is an external filter having self-cleaning tornado action using a single element, multi-layer stainless steel filter media. Another external cyclonic filter is made by Collins Products Co, maker of the SWIRLKLEAN brand bypass filter which uses a cyclone-type filter external to the pipeline, situated upstream the analyzer, although the SWIRLKLEAN system does not utilize gravity separation, instead exploiting a bypass technique as detailed at http://www.collins-products.com/.

To summarize, the prior art teaches various systems for removing liquid particulates or the like from a gaseous fluid stream. Removal of such entrained liquid is imperative as a component of gas analysis as detailed above, although such systems are imperfect and many designs can be overwhelmed by a liquid slug or the like. Anytime liquid is removed from the source and transported into the sample system, the liquid distorts the true composition of the sample.

However, due to shortcomings in the above systems there remains a long felt, but unresolved need in the industry for a system with the ability to reliably prevent liquids from overwhelming the separator, thus preventing sample distortion and contamination, which can equate to wrong analysis and very costly incorrect monetary exchanges.

It would therefore be an improvement over the art to provide a cyclonic separator system for removing liquid from fluid sample flow which may not rely solely upon a conventional membrane or filter, and overall requires less maintenance than the prior art systems currently available.

### GENERAL SUMMARY DISCUSSION OF THE INVENTION

Unlike the known prior art systems, the device of the present invention provides an effective liquid separator/filter which relies upon a more robust cyclonic separator technique, further providing the option to couple with a liquid block apparatus, and may or may not include a membrane (in cartridge or tube form) or other filter separator, which may be provided downstream therefrom. The system as shown in the present invention is compact and sturdy, and while preferably situated external the process flow stream, its compact size allows use in a variety of applications, and may even include insertion into the pressurized pipeline, to operate at the prevailing pressure and temperature, under certain circumstances.

The preferred embodiment of the present invention contemplates a unique cyclonic separator having a liquid block apparatus and a fluid separation membrane or filter downstream therefrom, providing up to triple liquid exclusion redundancy, thereby insuring that no fluid is present in the sample flow entering the analyzer/sampling apparatus, and that the sample gas leaving the system is “dry”.

The preferred embodiment of the present invention thereby provides a robust system for preventing entrained liquid from entering the sample stream to the analyzer while ensuring that a single, gas-phase sample, is taken.

An alternative embodiment of the present invention utilizes a cyclonic separator with the liquid block device and no membrane/filter, this embodiment being configured to substantially increase operation time between maintenance requirements, and dispense with the necessity of membrane/filter changes, albeit without the triple redundancy of the preferred embodiment, so this system is envisioned as being more suitable for less “wet” fluid streams.

The present invention can thereby reduce or may even eliminate the need for filter elements that must be replaced or cleaned. It protects the entire sample system from contamination that otherwise would require costly downtime for cleaning or replacement. By preventing undesired liquids from entering the sample, the present system lessens the likelihood of sample distortion and flawed analysis, especially when utilizing the current API and GPA sampling standards.

The preferred embodiment of the present provides a unique cyclone separator particularly suitable for high flow rate operation, the separator formed to receive fluid flow from an inlet, providing a first stage of liquid separation. The present embodiment then utilizes a liquid block downstream the cyclone separator/filter, the liquid block designed to prevent large slugs of liquid from reaching a coalescing element downstream therefrom, should the primary cyclone filter be overwhelmed by the liquid.

In the preferred embodiment, the liquid block is not flow sensitive, and it will only activate if liquid fills the area where a float or the like is located, so as to prevent same from being introduced into the membrane area of the device downstream therefrom. The exemplary embodiment of the liquid block of the preferred embodiment of the present invention utilizes a spring or other bias associated with said float to allow coalesced liquids to normally drain back through the liquid block, without the float sealing against the inlet of same during ordinary operation.

Finally, in the first embodiment of the invention a coalescing element, filter or the like in cartridge or tube form is provided to coalesce entrained mist or very fine aerosol droplets which might otherwise pass through the cyclone and liquid block, thus preventing same from being introduced into the sample system. The membrane is protected from large slugs of liquid by the upstream liquid block.

A second embodiment utilizes the first stage cyclone filter, but without any filter or coalescing element of any type behind the cyclone filter to minimize maintenance requirements, although a liquid block is provided downstream as required.

The inlet opening size, insertion diameter/clearance, and length and diameter of the conical section, as well as the outlet and drain diameters may need to be properly proportioned to optimize the flow-to-filter ratio of the cyclone filter. This ratio must be properly sized, taking into account the normal analytical flow rate in a gas or vapor-only single phase sample so that the cyclone filter supplies the appropriate flow of sample. Further, the passageways must also be sized so that when liquid slugs are present, the cyclone filter can remove the liquid prior to entering the sample stream intended for the analyzer.

The coalescing element downstream of the cyclone separator/filter could be formed of, for example, sintered plastic, or metal, spun borosilicate glass, membrane material, etc, and is preferably formed in tube or cartridge form.

Lastly, various other elements such as pressure reducer(s), etc can be provided downstream or even upstream the separator, as necessary and/or desirable.

### BRIEF DESCRIPTION OF DRAWINGS

For a further understanding of the nature and objects of the present invention, reference should be had to the following detailed description, taken in conjunction with the accompanying drawings, in which like parts are given like reference numerals, and wherein:

FIG. 1A is a side, partially cutaway view of the first, preferred embodiment of the present invention, illustrating a cyclone-type (also referenced as “cyclonic”) separator/filter, the present embodiment further illustrating a liquid block downstream of the cyclonic separator, and a coalescing element downstream the liquid block.

FIG. 1B is a side view of the second, alternative embodiment of the device of FIG. 1A, viewing through inlet 10, the second embodiment provided with the cyclonic separator and liquid block, but without the coalescing element provided shown in the first embodiment of FIG. 1A.

FIG. 2A is a side view, partially cutaway view of the invention of FIG. 1B, illustrating via arrows fluid flow/liquid separation, and draining port.

FIG. 2B is a side, partially cutaway view of the invention of FIG. 2A showing inlet 10.

FIG. 3 is a side, cutaway view of the first embodiment of FIG. 1A, illustrating fluid flow via inlet, outlet, bypass, and drain.

FIG. 4 illustrates the second embodiment of FIG. 1B, showing threaded connections for the components, which may have the feature of a unique threaded or spiraled exterior (threads 20) of insert 4 to facilitate spiral or cyclonic flow about the insert from inlet to separation funnel/cyclonic chamber 3.

FIG. 5 is a side, partially cutaway view of the invention of FIG. 4, illustrating via phantom internal structure of the various components shown.

FIG. 6 is a side, exploded view illustrating the various components of first, preferred embodiment of the cyclonic device of FIG. 1A, illustrating in phantom the internal structure of same.

FIG. 7 is a side, exploded view of the device of FIG. 1A with the added feature shown of the incorporation of the unique threaded or spiraled exterior of insert utilized with the device to facilitate spiral or cyclonic flow about the insert from inlet to separation funnel/cyclonic chamber 3, the insert further containing a coalescing element 5 and liquid block 6 therein, formed for fluid passage therethrough to outlet 7.

### DETAILED DISCUSSION OF THE INVENTION

Referring to the drawings, the present invention comprises a cyclone separator in the form of a separation funnel/cyclone chamber 3 (may also be referenced as cyclone filter) the first embodiment 1 further incorporating a liquid block 6 downstream the cyclone chamber, the liquid block 6 being formed to block slugs of liquid that might overwhelm the cyclonic separator, keeping said liquid. Thus the coalescing element 5 is protected from substantial liquid contact, thus prolonging its useful life as well as the period before it would need to be replaced. Coalescing element 5 is situated to receive and capture, via coalescence, entrained mist or very fine aerosols, so as to prevent same from being introduced into the sample stream downstream the coalescing filter.

In both the first 1 and second 2 embodiments of the invention, if a slug of liquid is present in the sample stream entering the cyclone filter, said fluid flow passes through separation funnel/cyclone chamber 3 which can (within limits) separate said slug of liquid (or any residual liquid therefrom) and prevent same from passing through outlet port 7 leading to the sample system.

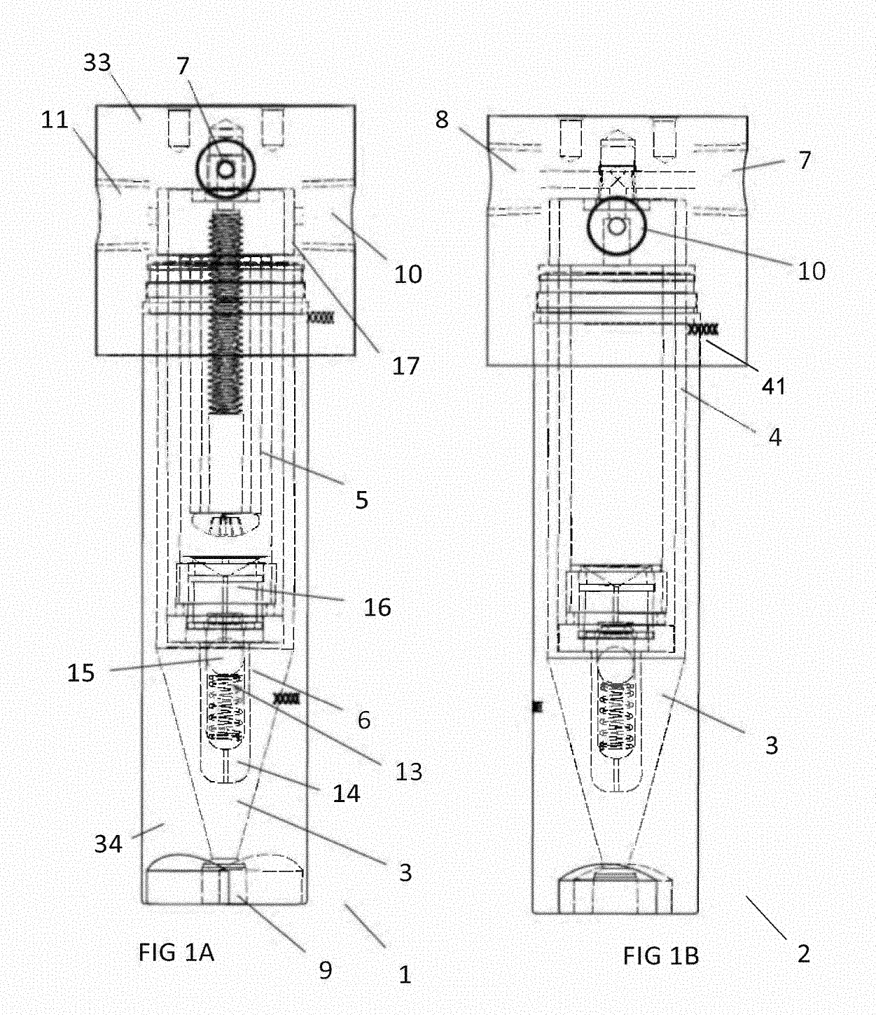

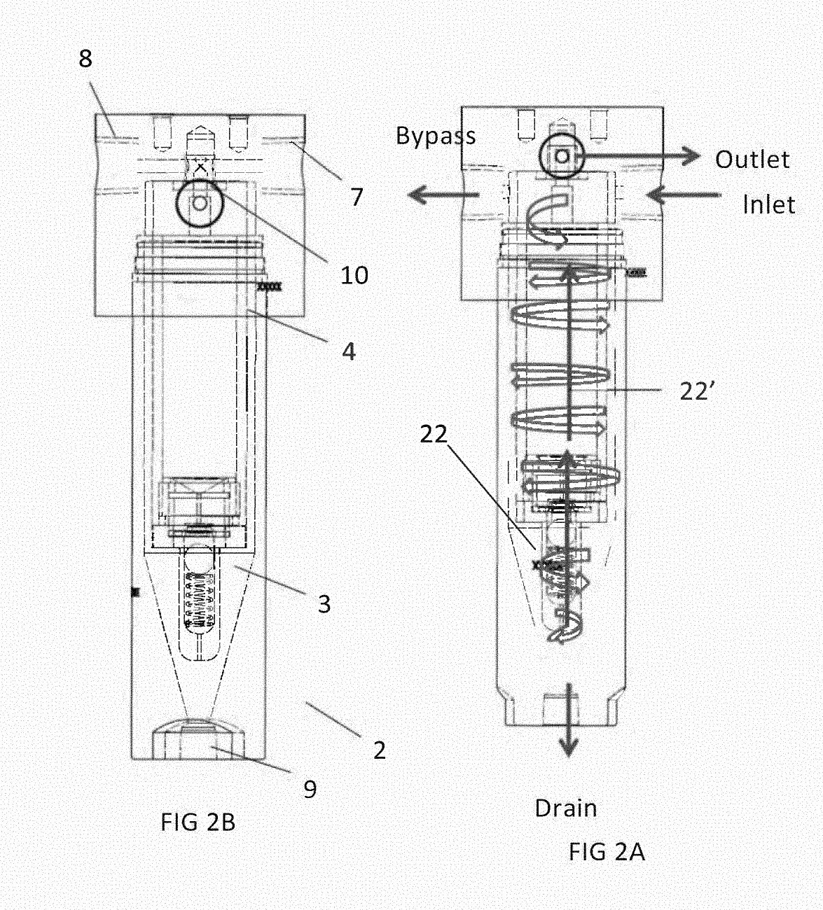

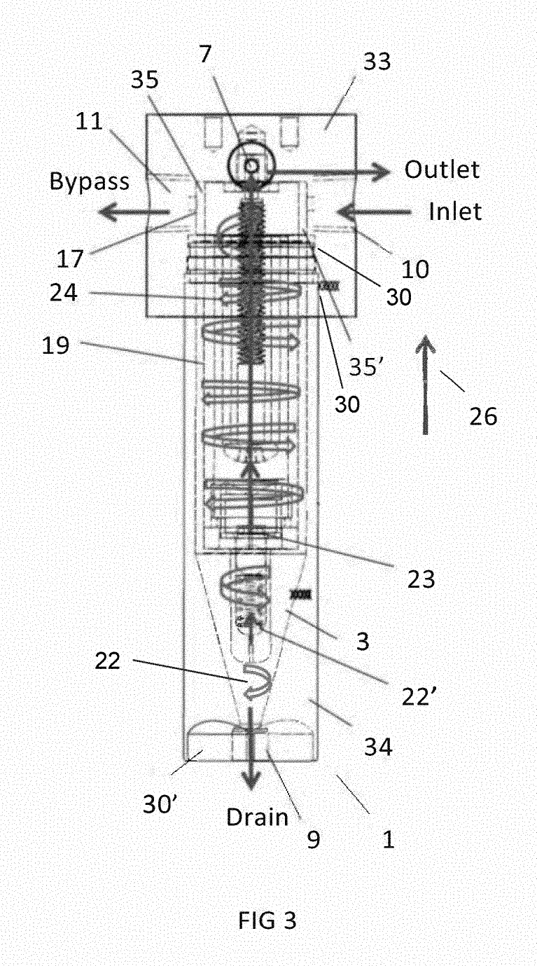

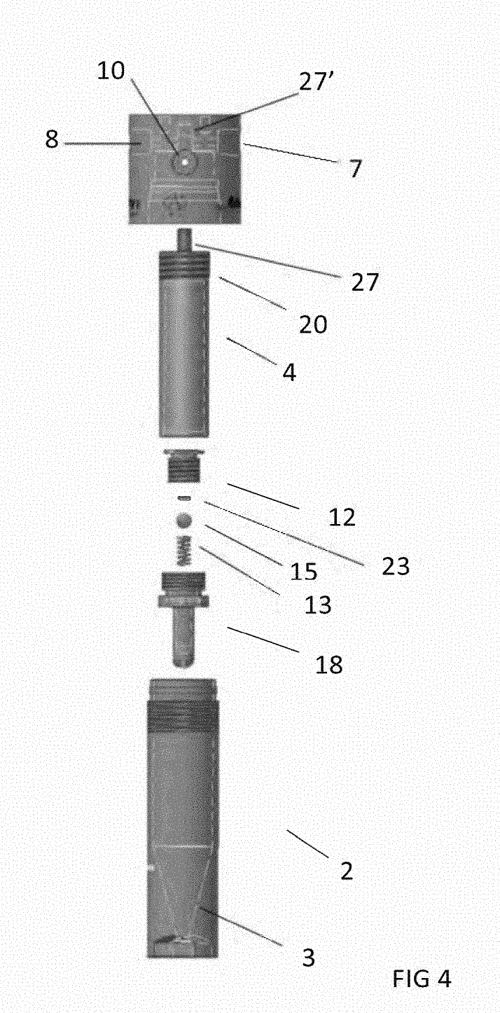

Continuing with FIGS. 1-4, the cyclonic separator/filter of the present invention comprises a base 33 to which a housing 34 (alternatively referenced as a sleeve) is removably affixed thereto. An outlet 7 is provided (shown formed in base 33) to engage an outflow passage leading to a sample analyzer, container, etc.

Base 33 engages said housing 34 via threaded connection 41 or the like, said housing 34 formed to house insert 4 (shown having a cylindrical configuration) and formed to be enveloped by a cylindrical inner walls 35, 35′ formed in base 33 and housing 34, respectively, forming a clearance 17 therebetween for passage therethrough, as will be further discussed herein.

Insert 4 includes an extension 27 emanating therefrom formed to engage the base at receiver 27′ so as to provide a passage to outlet 7. The outer surface of extension 27 may be threaded to threadingly engage receiver 27′ formed in base. An o-ring or other seal may be provided to sealingly connect the two components, and insure a fluid seal therebetween.

Housing 34 may also be threaded at its first end 30 so as to threadingly engage base 33, and a seal such as an O-ring or the like may be provided as required for a fluid-tight connection.

Formed within housing 34 is a conical cavity forming a tunnel/cyclone chamber 3 tapering from its widest point to an end or apex having a drain 9 in the vicinity of the second end 30′ of housing.

Continuing with the figures, the present invention is shown having an inlet 10 and bypass 11 port associated with base 33, the inlet formed to receive a process flow or the like via a conduit or such so as to facilitate fluid flow 24 tangentially therein and about the passage formed by clearance 17.

A portion of the fluid flowing via inlet 10 passes through clearance 17 and exits via the bypass 11, the remaining flow 24 spiraling via clearance 17 between insert 4 and inner walls 35, 35′ formed by base 33 and housing 34 respectively, said flow spiraling about and down along the outer surface 19 of insert 4 to the inverted cone-shaped portion forming the separation funnel/cyclone chamber 3, said chamber 3 formed to further facilitate cyclonic, centrifugal action within the chamber, forming a vortex 22 to facilitate liquid separation as the gas of the sample flow is drawn upward 22′ through the lower pressure center of the vortex, the liquid separated via cyclonic action and gravity, flowing to drain 9.

Most or all liquid particulates in the fluid stream are thereby cyclonically extracted from the stream and drain through drain port 9, with any slugs of residual liquid being blocked by liquid block 6 downstream therefrom. Any mists or fine aerosols are taken out by coalescing element 5 downstream therefrom (in the first embodiment 1 of the invention where such element 5 is provided), as will further be discussed herein.

Note again that the coalescing element 5 may be situated within insert 4 downstream the liquid block 6, which engages the distal end of insert 4 and is at the mouth of the separation funnel/cyclone chamber 3. The present configuration allows excess liquid coalesced by the membrane to collect and drip back into the funnel/cyclone chamber, where it is separated via the cyclonic action and drained via drain 9.

Stacking or nesting of the coalescing element 5 within insert 4 in the first embodiment of the invention 1 decreases the amount of space required when compared to prior art systems. The cartridge or tube form of membrane (shown in cylindrical form forming an interior) also increases the membrane surface area allowing for high flow applications that are not particularly feasible with a conventional disk membrane in the same space. The cylindrical or tube membrane could be of the same size (filtration area) and operational criteria as that of the Genie Probe Membrane, to allow for commonality of inventory.

The liquid block could be of the float type, which is not as flow dependent as the disk-type membrane liquid block can be. The liquid block before the membrane can thereby decrease the likelihood that the coalescing membrane will directly counter substantial liquid, and thus may last longer before needing to be replaced.

In the preferred, first embodiment 1 of the present invention, the liquid block is provided downstream of the cyclonic separator and upstream of the coalescing element. The preferred embodiment of the liquid block 6 is configured to float and lift to engage seal 23 to prevent passage of liquid there through in the event the cyclonic separator is overwhelmed with liquid.

In the present, first 1 embodiment illustrated embodiment, a liquid block device 6 is provided, the preferred, exemplary embodiment thereof includes a float 15 that rises as the chamber fills with liquid so that the float seals on the o-ring 23′ at the top of the chamber, sealing off the liquid so that it cannot exit the liquid block. The liquid block includes a spring 13 under the float so that coalesced liquids can drain back through the liquid block without the float sealing against the inlet of the liquid block. The preferred embodiment of the liquid block of the present invention is designed so as not to be gas flow dependent, and is formed to be either in an open, flowing position, or a closed, flow blocking position, and is not designed to throttle liquid flow.

Thus flow of a liquid stream or slug is thereby effectively blocked. Any mists or fine aerosols passing through the liquid block are coalesced by the coalescing element (cartridge or tube membrane in this embodiment) so that any sensitive equipment (i.e. analyzer) downstream the system is protected from liquid contamination.

In the preferred embodiment of the present invention, fluid flowing through the liquid block is positioned to flow into insert 4, which may have coalescing membrane situated therein, as earlier discussed. The coalescing element 5 of the preferred embodiment of the invention is of a cylindrical configuration, situated within and in axial alignment with insert 4 such that fluid flowing from the liquid block passes into insert, where it is directed to the outer surface of the coalescing element 5, in the preferred embodiment formed of coalescing membrane, so as to allow the passage of fluid therethrough while excluding entrained fluids, providing dry gas therein, which dry gas flows through coalescing element and out of the system for sampling or other purposes.

The membrane forming coalescing element 5, being in tube or cylindrical form as shown (and can be in the form of a cartridge), provides more surface area, and is protected within insert. Further, being downstream the liquid block, the membrane is protected from direct contact from substantial flows of liquid, prolonging its service life while maintaining active separation areas available for flow therethrough.

In both the first 1 and second 2 embodiments of the present invention, it is noted that the configuration of the cylindrical insert 4 can vary depending upon the application and associated needs, including, for example, a linear or blade configuration, a triangular or polygonal configuration as well as others, which may be interchangeably changed as the need arises.

To facilitate the desired downwardly descending spiral flow as the fluid flows along from inlet about the outer surface of insert 4, threads 20 can be provided about the outer diameter of the cylinder insert 4. The sizes and scales of the inserts may vary depending upon the application to vary the clearance between said insert and the outer housing, which forms the passage for the fluid stream flowing thereabout and therethrough.

The inlet opening size and the length and diameter of the conical section and internal barrier, as well as the outlet and drain diameters may need to be sized for the flow to filter ratio of the cyclone filter/separator. This ratio must be sized correctly so that under normal analytical flow rates in a gas or vapor only single phase sample, the cyclone filter supplies the appropriate flow of sample.

In addition, the passageways must also be sized so that when liquid slugs are present, the cyclone filter can remove the liquid in sample intended for the analyzer. The material of construction of the coalescing element of the first embodiment 1 may be application dependent (i.e. may depend on process fluid, analytical flow rate, the properties of the type of liquid entrained, etc.). Ideally, the float of the liquid block is formed to block flow of at least a predetermined minimum amount (the liquid slug), that is, the liquid slug must have sufficient support capacity to lift any float situated thereupon.

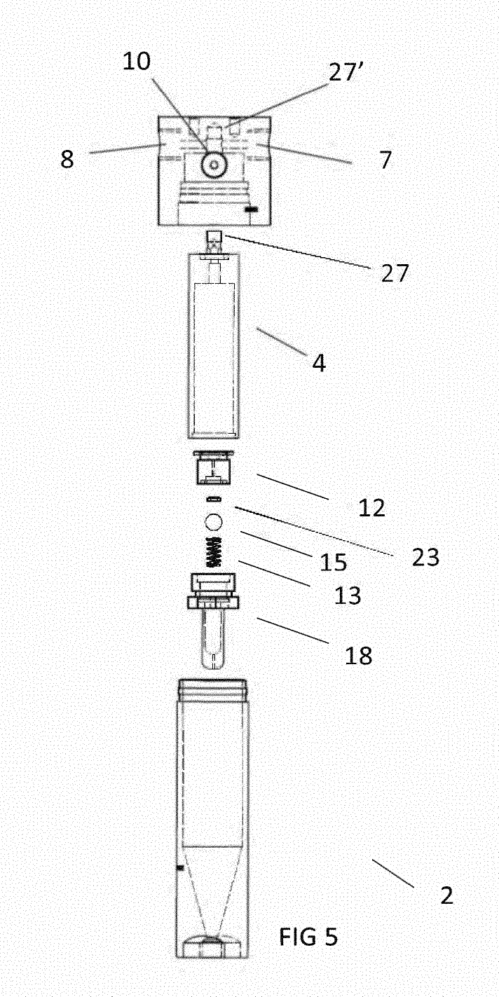

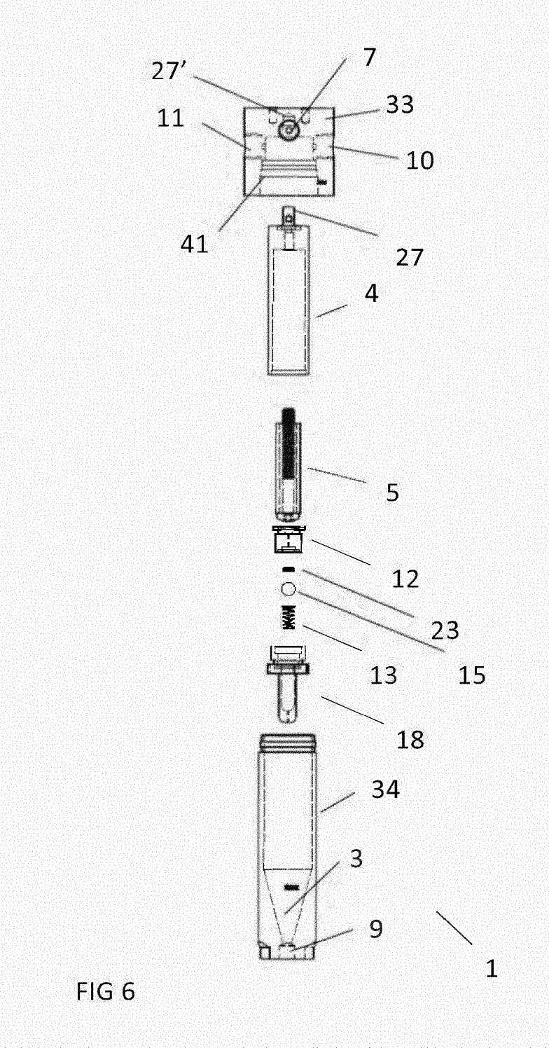

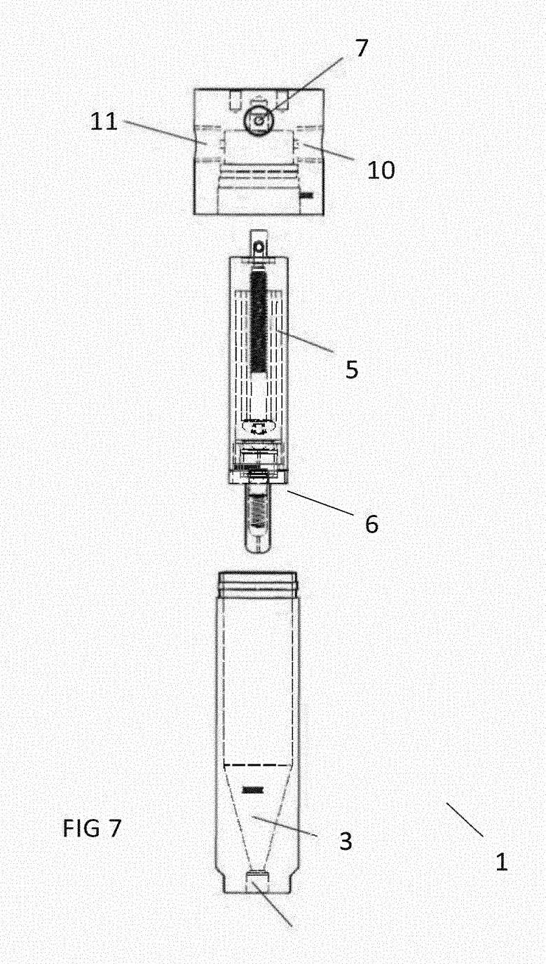

Continuing with FIGS. 1B, 2A-2B, 4 and 5, the second embodiment of the present invention would utilize a cyclone separator/liquid block formed in a housing engaging a base similar in concept to that taught in the first embodiment, but without the coalescing filter, as such a component may not be required when the likelihood of encountering substantial entrained liquids in the flow stream is low, and accordingly may not be required in all cases. Accordingly, the second embodiment can provide an effective, compact, low maintenance, and reliable liquid separator using cyclonic separation with liquid block as a backup, providing treated gas therefrom to outlet port 7 in flow streams without excessive liquids present therein and in installations where such separation is compliant with the desired operational specification.

### ELEMENTS OF THE INVENTION

1 first embodiment of cyclone separator
2 second embodiment
3 separation funnel/cyclone chamber
4 insert
5 coalescing element/membrane filter tube cartridge
6 liquid block
7 outlet port
8 outlet port
9 drain port
10 inlet port
11 bypass port
12 top half of liquid block
13 liquid block spring
14 liquid block inlet
15 liquid block float
16 liquid block exit/coalescing element drain
17 clearance
18 bottom half of liquid block
19 outer surface of insert 4
20 threads
22,′ vortex, upward
23 liquid block seal, 23′ O-ring
24 fluid flow
26 build up
27,′ extension, receiver
30, 30′ first second ends of housing
33 base
34 housing
35,′ cylindrical inner walls
41 connection

The embodiments listed are not intended to be an exhaustive list of applications for the cyclone filter but only intended to show the need and some of the practical applications of the invention. Further, the invention embodiments herein described are done so in detail for exemplary purposes only, and may be subject to many different variations in design, structure, application and operation methodology. Thus, the detailed disclosures therein should be interpreted in an illustrative, exemplary manner, and not in a limited sense.

I claim:

1) A device for sampling a fluid in a fluid stream, comprising:
a base formed to receive a fluid stream;
a housing formed to engage said base, said housing containing a cyclone chamber formed therein, said cyclone chamber having an internal geometry formed to facilitate cyclonic activity so as to separate liquid from said fluid stream passing therethrough, so as to provide a treated fluid stream;
an insert having an outer surface, said outer surface formed to engage said fluid stream so as to direct same to said cyclone chamber in association with said housing, said insert formed to receive said treated fluid stream and direct same to an outlet.

2) The device of claim 1, wherein said cyclone chamber comprises a conical section having a liquid drain formed therethrough.

3) The device of claim 2, wherein said housing is threadingly affixed to said base.

4) The device of claim 2, wherein said base has an inlet for receiving said fluid.

5) The device of claim 4, wherein there is provided a liquid block mounted downstream said cyclonic separator.

6) The device of claim 5, wherein there is provided a coalescing element downstream said liquid block.

7) The device of claim 5, wherein said insert has a cylindrical configuration forming an interior, and said coalescing element is situated within the interior of said insert.

8) The device of claim 7, wherein said coalescing element has a cylindrical configuration having an interior forming a flow passage formed to receive filtered fluid therethrough.

9) The device of claim 7, wherein said liquid block comprises a moveable body formed to selectively engage a seal whereby, upon liquid flowing into said liquid block, said moveable body is formed to urge said seal to engage said seal, so as to prevent the flow of said liquid mass therethrough.

10) The device of claim 8, wherein said moveable body comprises a float formed to float upon a liquid such that, upon a liquid mass flowing into said liquid block, said float is positioned to engage said seal to sealingly engage same, preventing the flow of said liquid mass through said liquid block.

11) The device of claim 8, wherein said seal comprises gasket material.

12) The device of claim 8, wherein said seal comprises an o-ring.

13) The device of claim 2, wherein said fluid stream is directed from a process gas stream in a pipeline, said device being situated exterior said pipeline.

14) The device of claim 1, wherein the internal geometry of said cyclonic separator is in the form of an inverted frustoconical chamber having a drain formed therethrough.

15) The device of claim 2, wherein
said insert is formed to engage said base, said insert having a cavity formed therein, and an cylindrical outer surface;
said cyclone chamber formed in said housing so as to facilitate the formation of a vortex for the separation of liquid from gas upon a fluid stream passing therethrough,
said housing further comprising a drain aperture to drain liquid therefrom.

16) The device of claim 7, wherein there is further provided a liquid block formed to provide selective fluid flow to the cavity of said insert, and to a coalescing element.

17) The device of claim 16, wherein said coalescing element is situated within said cavity of said insert.

18) The device of claim 17, wherein said coalescing element is cylindrical and has formed therein an interior, so as to form a passage for filtered fluid.

19) The device of claim 18, wherein said coalescing element has an outer wall formed of a coalescing membrane which is formed to receive a therethrough a fluid stream while preventing the passage of entrained liquid therein.

20) A method of separating a gas from a gas/liquid flow to provide a dry sample stream, comprising the steps of:
a. providing a device comprising:
ai. a base formed to receive a fluid stream;
aii. a housing formed to engage said base, said housing containing a cyclone chamber, said cyclone chamber having an internal geometry formed to facilitate cyclonic action to separate liquid from said fluid stream, providing a treated fluid stream;
aiii. an insert having an outer surface, said outer surface formed to engage said fluid stream so as to direct same to said cyclone chamber, said insert having an interior formed to receive said treated fluid stream and direct same to an outlet;
aiv. a liquid block; and
av. a coalescing filter;
b. engaging said insert to said base;
c. engaging said housing to said base so that said housing envelopes at least a portion of said insert, forming a clearance between said outer surface of said insert and said housing;
d. positioning said liquid block in said housing to receive flow from said cyclone chamber;
e. positioning said coalescing filter in said insert to receive flow from said liquid block;
f. flowing a fluid stream comprising gas having liquid therein into said housing, about said insert via said clearance between said insert outer surface and said housing, to said cyclone chamber,
g. allowing said internal geometry of said cyclonic chamber to facilitate formation of a cyclone therein;
h. using said cyclone to facilitate separation of liquid from said fluid stream, providing a cyclonically separated fluid stream;
I. draining said liquid, while facilitating the passage of gas therethrough.
j. flowing said cyclonically separated fluid stream through said liquid block, allowing said liquid block to block liquid therein, draining same, while providing liquid block separated fluid;
k. flowing said liquid block separated fluid through said interior of said insert, to said coalescing filter, providing filtered gas;
l. flowing said filtered gas through said coalescing filter and out of said device.

21) The method of claim 20, wherein in step “j” said liquid comprises a liquid slug.

22) The method of claim 21, wherein said coalescing filter of step av. comprises a coalescing membrane and there is further provided the sub-step l(I) of using said coalescing membrane to prevent the passage of entrained liquid therethrough, and draining same via same liquid block.

23) A method of sampling a gas stream having entrained liquid therein, comprising the steps of:
a. providing a device comprising:
ai. a base formed to receive a fluid stream;
aii. a housing formed to engage said base, said housing containing a cyclone chamber formed therein, said cyclone chamber having an internal geometry formed to facilitate a cyclone so as to separate liquid from said fluid stream, providing a treated fluid stream;
aiii. an insert having an outer surface formed to engage said fluid stream so as to direct same about same to said cyclone chamber, said insert formed to receive said treated fluid stream;
b. engaging said insert to said base;
c. engaging said housing to said base so that said housing envelopes at least a portion of said insert, forming a clearance between said outer surface of said insert and said housing;
d. receiving a flow of a said gas stream having entrained liquid into said base, providing a sample flow;
e. directing a portion of said sample flow about said outer surface of said insert via said clearance to said cyclone chamber;
f. allowing said sample flow to interact with said cyclonic chamber to form a cyclone;
g. using said cyclone to separate liquid from said sample flow, providing a separated sample flow;
h. draining said liquid into said process gas stream.

25) The method of claim 24, wherein there is further provided after step aii. the added sub-step aii(a) of providing a liquid block downstream from and in fluid engagement with said cyclone chamber, and after step “h” providing the added step “i” of flowing said separated sample from said cyclone chamber through said liquid block, and utilizing said liquid block to block flow of liquid streams therethrough.

26) The method of claim 25, wherein there is provided after aii(a) the added step aii(b) of providing a coalescing filter in said insert downstream from and in fluid engagement with said liquid block, and after step “i” providing the added step “j” of flowing said separated sample flow from said liquid block, through said insert and to said coalescing filter, utilizing same to prevent the passage of entrained liquid therethrough, draining said entrained liquid via a drain via said cyclone chamber, providing dry sample flow via said coalescing filter.

26) The method of claim 27, wherein there is further provided after step “j” the added step “k” of flowing said dry sample flow out of said coalescing filter, through said base to an analyzer.

27) The method of enhancing the life of a coalescing membrane, comprising the steps of:
a. flowing a fluid through a cyclonic separator, separating liquid from said fluid flow and draining same, providing cyclonically separated fluid;
b. flowing said cyclonically separated fluid through a liquid block, and utilizing said liquid block to prevent the passage therethrough of any slugs of liquid, draining same, further decreasing liquid in said cyclonically separated flow, providing liquid separated fluid;
c. flowing said liquid separated fluid to said coalescing membrane, while preventing over-saturation of said membrane with liquid.
